(19) United States
(12) Patent Application Publication
(10) Pub. No.: US 2024/0289154 A1
(43) Pub. Date: Aug. 29, 2024

(54) INVOKING A HOST PROCESS FROM WITHIN A CONTAINER TO OUTLIVE THE CONTAINER LIFESPAN

(71) Applicant: DELL PRODUCTS L.P., Round Rock, TX (US)

(72) Inventors: Oleksandr BABIYCHUK, Ottawa (CA); Alykhan NATHOO, Ottawa (CA)

(73) Assignee: DELL PRODUCTS L.P., Round Rock, TX (US)

(21) Appl. No.: 18/175,494

(22) Filed: Feb. 27, 2023

(51) Int. Cl. G06F 9/455

(52) U.S. Cl. CPC G06F 9/45558; G06F 2009/45587

(57) ABSTRACT

Presented herein are embodiments for starting a host process from within a container via a proxy process. In one or more embodiments, the container delegates creation and maintenance of a host process (e.g., a daemon process) to the proxy process—thereby removing the host process's lifecycle dependent to the container's lifecycle. Thus, no service impact occurs when the container is terminated or restarted. In one or more embodiments, a host process, like an SSH server, may be used as a proxy process for creating, on behalf of a container, a host process (e.g., a daemon process), in which the host process's hierarchical dependency is not dependent on the container. Termination of the daemon process and any other controls may be (but do not have to be) done through the proxy process. In one or more embodiments, when the daemon process is running, it may provide its own communication/control interface.

### BACKGROUND

### A. Technical Field

The present disclosure relates generally to information handling systems. More particularly, the present disclosure relates to computer processes running in different environments.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A container in a computing or networking environment is a standalone executable package that includes everything needed to run a piece of software—including the code, runtime, system tools, libraries, and settings. Containers provide a way to package and distribute software in a self-contained and isolated environment, which ensures that the software will run consistently across different computing environments.

A key idea behind containers is to separate the application and its dependencies from the underlying operating system and hardware, so that the application can run in any environment, on any host, and on any infrastructure, without modification. This makes it possible to deploy and run complex applications with ease, and to manage the lifecycle of these applications in a flexible and scalable way.

Containers use a technology called containerization, which allows multiple containers to run on the same host, isolated from each other, while sharing the underlying host operating system and hardware. This provides a high level of operational and security benefits, as containers are more secure, portable, and scalable than traditional virtualization technologies.

Popular container-related software includes Docker, Kubernetes, and OpenShift. Docker is a container runtime and images building tool. Kubernetes and OpenShift are container orchestrators, which are built on top of a container runtime, that may be used for managing containers, control their lifecycle, etc. Container platforms provide a set of tools and services for building, deploying, and managing containers, making it easier for developers to create and deploy complex applications in containers.

When a process runs within a container its life is limited to the lifespan of the container. This can limit functionality if the container is terminated as part of its lifecycle, which is often the case in environments such as a Kubernetes environment.

Another limitation for container technology is when the container, at some specific point in time, must perform some other major functionality different from that which it was originally intended. This functionality in some cases may require long-term availability beyond the life of the container. However, when the container terminates, the associated functionality also terminates.

Accordingly, it is highly desirable to find new systems and methods for allowing functionality initially invoked by a container to have longevity beyond the lifecycle of the originating container.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 (“FIG. 1”) depicts an example of an existing process, in which the daemon process's lifespan is dependent upon the originating container process's lifespan. That is, the daemon process is created by the container main process (i.e., entrypoint) and is terminated by the kernel as soon as the container exits (i.e., the entrypoint and containerd-shim process exit).

FIG. 2 graphically illustrates invoking a host process from a container process via a proxy process, according to embodiments of the present disclosure.

FIG. 3 depicts a methodology for invoking a host process from a container using a proxy process, according to embodiments of the present disclosure.

FIG. 4 graphically depicts a scenario in which the originating container process ended but the host daemon process remains active, according to embodiments of the present disclosure.

FIG. 5 depicts an example methodology for establishing connection between a new container instance and an existing host daemon process, according to embodiments of the present disclosure.

FIG. 6. graphically depicts an example scenario in which a proxy process has been terminated but the host daemon process remains alive, according to embodiments of the present disclosure.

FIG. 7 depicts an example methodology for establishing connection between a new container process instance and an existing host process, according to embodiments of the present disclosure.

FIG. 8 graphically depicts an example of handling an existing host daemon process given a new instance of a proxy process, according to embodiments of the present disclosure.

FIG. 9 depicts an example methodology for handling a new proxy process instance, according to embodiments of the present disclosure.

FIG. 10 depicts an example use case involving an encryption driver, according to embodiments of the present disclosure.

FIG. 11 depicts a simplified block diagram of an information handling system, according to embodiments of the present disclosure.

FIG. 12 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall also be noted that although embodiments described herein may be within the context of Linux operating systems or with daemon processes, aspects of the present disclosure are not so limited. Accordingly, the aspects of the present disclosure may be applied or adapted for use in other contexts.

### A. General Overview

A container is a type of virtualization technology that allows for the running of an isolated environment within a single operating system. Containers provide a way to package and distribute applications and their dependencies, so that they can run consistently across different computing environments, including different servers, desktops, and cloud platforms.

Containers differ from traditional virtualization, such as virtual machines (VMs), in that containers do not require a separate operating system for each instance. Instead, containers typically share the host operating system's kernel and rely on (at least for Linux environments) namespaces and cgroups, two Linux kernel features, to provide isolation and resource management.

Containers can provide several benefits over traditional virtualization. For example, containers provide portability—containers can be easily moved between environments, without any compatibility issues. Second, containers are lightweight—containers are smaller and faster to start and stop than VMs. Third, containers are resource efficient—containers can share the host's resources, making better use of system resources. Fourth, containers are scalable—containers can be easily replicated and deployed to meet the demands of an application, making it easier to scale applications horizontally. Finally, containers are repeatable—containers provide a consistent environment for an application, ensuring that it will always run the same way, regardless of the host environment.

While containers have several benefits, they are not without limitations. As noted above, when a process runs within a container its life is limited to the lifespan of the container. This can limit functionality if the container is terminated as part of its lifecycle, which is often the case in a Kubernetes environment. Also, container technology is limited when the container must perform some other major functionality different from that which it was originally intended. This functionality in some cases may require long-term availability beyond the life of the container.

A solution to these problems may comprise, from within the container, invoking the additional functionality outside of the container, directly on the compute host that hosts the container, by starting a daemon process that runs on the host, and is governed by the host's lifecycle, which naturally can survive beyond the lifecycle of the container, thereby maintaining and sustaining the required functionality.

The container runtime (known as containerd in Linux, for example, which is commonly used in the Kubernetes environment) is designed so that any descendant process of the container main process is terminated by the kernel when the container main process exits. Even when a child process is created outside of the container process ID namespace (PID namespace), it remains a descendant of the container main process.

A PID namespace is a feature in operating systems, such as Linux, that isolates the process IDs of a set of processes from other processes on the system. Each PID namespace typically has its own range of PIDs that are unique within that namespace, and PIDs assigned within a namespace typically do not have to be unique across namespaces. With PID namespaces, multiple instances of the same process can exist simultaneously on the same system, each with its own PID, and they will not interfere with each other. This is particularly useful in containers, where multiple containers can run on the same host, each with its own isolated environment, including its own set of processes with unique PIDs.

PID namespaces may be created by a system call (e.g., a clone( ) system call, with the CLONE_NEWPID flag). Once a process has been created in a new PID namespace, its child processes will be assigned PIDs from the namespace's PID range, and the process hierarchy (e.g., parent-child dependency) within the namespace will be independent from the process hierarchy in the parent namespace. The init process within a PID namespace is typically assigned PID 1, and is responsible for managing the processes within the namespace.

It is also impossible to re-parent a container child process to another process beyond the container processes tree through the mechanism of adoption of orphaned children processes. This possibility is blocked by presence of a so-called child reaper in the container process tree because: (1) if the container is using an isolated PID namespace, its main process implicitly becomes the reaper of orphaned descendant processes; and (2) if the container is using the host PID namespace, the container supervisor process (sometimes referred to as a shim) becomes the reaper of orphaned descendant processes. This mechanism re-parents an orphaned child process, regardless of its PID namespace, to either the container main process or the container shim process. An example of such a situation is a Kubernetes Container Storage Interface (CSI) driver, running as a container. When provisioning a CSI volume, the driver may need to spawn a daemon process as part of the volume data path. Once the volume is setup by the driver and is attached to an application container, the daemon process should keep running to service the application data input/output (I/O). Normally, this means the driver container cannot stop while there is any provisioned volume.

A “child reaper” is a process in operating systems, such as Linux, that is responsible for cleaning up child processes that have terminated. When a child process terminates, it becomes a “zombie process” or “orphaned process,” which retains some information about the process, such as its PID, exit status, and resource utilization, until its parent process collects this information. However, if the parent process does not collect the information, the zombie/orphaned process will remain in the system, taking up valuable resources and clogging up the process table.

The child reaper is a process that is responsible for collecting the information about terminated child processes, freeing up resources, and releasing the process table entries. In Linux, the init process is usually the child reaper. When a child process terminates, the kernel sends a signal to the parent process, which is responsible for collecting the information about the terminated child. Typically, if the parent process ignores the signal, the init process will collect the information, freeing up resources and releasing the process table entry. Thus, the child reaper is an important component of process management system, as it ensures that terminated child processes do not persist as zombie processes, taking up valuable resources and clogging up the process table.

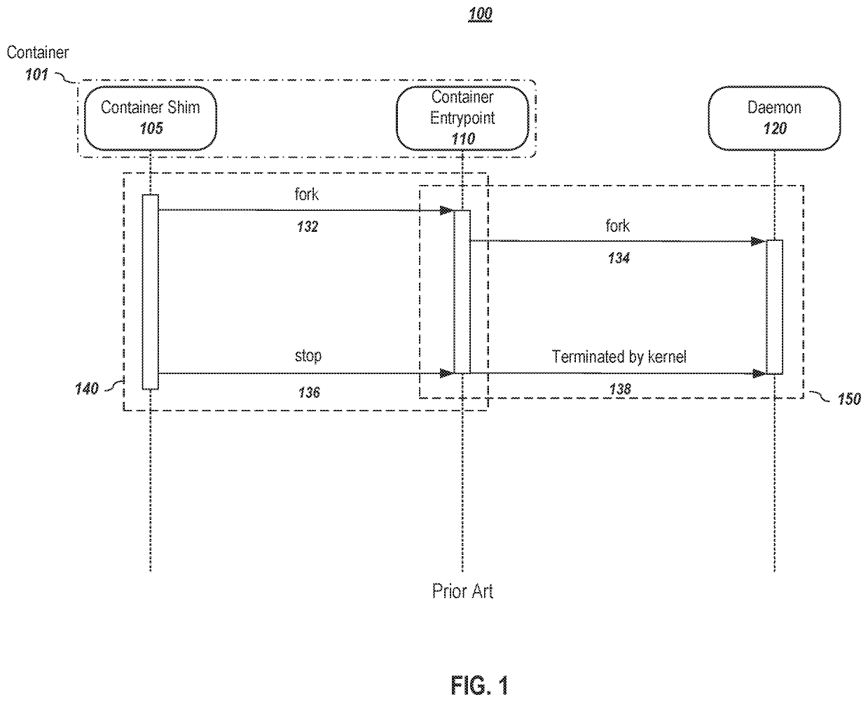

Consider by way of illustration, an example of current existing process, which is graphically illustrated in FIG. 1. FIG. 1 shows a container 101, which comprises a container runtime component 105 called “containerd-shim” and a container entrypoint 110. In the depicted example, the container shim 105 causes a container entrypoint 110 to be created via a fork operation/call 132. In the context of computing, a “fork” typically is a system call that creates a new process by duplicating the existing process. In Linux, the fork system call is used to create a new child process, which may be an exact copy of the parent process, including the values of all its variables, file descriptors, and other attributes. The new process created by the fork system call may be referred to as the child process, while the original process may be referred to as the parent (or originating) process. The child process may then modify its own variables and file descriptors without affecting the parent process, allowing for parallel execution of multiple tasks. Forking may be considered an important concept in operating systems, such as Linux, as it forms a basis for many advanced features, such as multitasking, inter-process communication, and process management.

As illustrated in FIG. 1, the container entrypoint 110 makes a fork call 132. The fork call results in creation of a host process, in this case a FUSE (file system in userspace) daemon 120. Note that the dashed rectangles 140 and 150 represent direct child-parent dependencies and also correlate to PID namespaces.

Continuing with FIG. 1, if the container stops or is terminated 136, the child process (i.e., the daemon process 120) is terminated 138 by the Linux kernel as soon as the container exits (i.e., the entrypoint and containerd-shim processes exit). If it was desired that the daemon process was to outlive the originating process, it cannot as the entrypoint 110 was the child reaper in this instance.

Currently, there are no known solutions. As a result, a running daemon process serving an application on behalf of a container has dependency on the container lifecycle.

It may be possible to have a long-living daemon process containerized and managed separately from the main container; however, this approach makes it impossible to treat the main container and the daemon as a single deployment unit, which undermines functionality of such deployment tools like Helm. Another possible alternative may be to have the daemon process created outside of the main container process tree during the compute host startup which will be only used by the main container when needed, idling the rest of the time. A major disadvantage, besides the need of a separate mechanism to manage that daemon process, is that it is only possible in some cases. For example, certain encryption implementations require a long-living daemon process (e.g., a FUSE daemon) for every encrypted volume, which may be requested by Kubernetes any time; so it is not possible to know in advance how many FUSE daemons will be required and with which encryption keys.

Embodiments herein remove the dependency of a host process (e.g., a daemon process) from the lifespan of the originating container process that initiated the host process. In one or more embodiments, the creation of the host process (e.g., a daemon process) is delegated to a process running outside of the container process tree that acts as a proxy process for the originating container process.

### B. System and Method Embodiments

Embodiments may be considered to employ the concept of a process (i.e., a proxy process) running on the information handling system host where the container is running and to which the container delegates creation and maintenance of a functional process (e.g., a daemon process). Workflow embodiments presented in this patent document leverage the generic notion of the proxy process and may be implemented using existing technologies as demonstrated in the examples below. In one or more embodiments, the proxy process may be any process outside the container that satisfies one or more of the following criteria:
the proxy process provides at least one-way communication interface for a container process to use. That is, preferably it provides an interface through which the container can request spawning a daemon process.
the proxy process may be used as a proxy that spawns a host process (e.g., a daemon process) on behalf of the container.
the proxy process may not be related to the container PID namespace or the container process tree.
the proxy process is a long-living process or has a long-living process reaper ancestor. That is, it may be a persistently running process with a lifespan exceeding the required lifespan of the created daemon process. Alternatively, it may be a descendant of a long-living process which adopts orphaned descendant processes (e.g., a child reaper).

In one or more embodiments, termination of the daemon process and any other control may (but does not have to be) done through the proxy process. A primary function of the proxy process for this purpose is to create the daemon process outside of the container process tree. When the daemon process is running, it may provide its own communication/control interface.

### 1. Embodiments of Initial Host Process Invocation by a Proxy Process

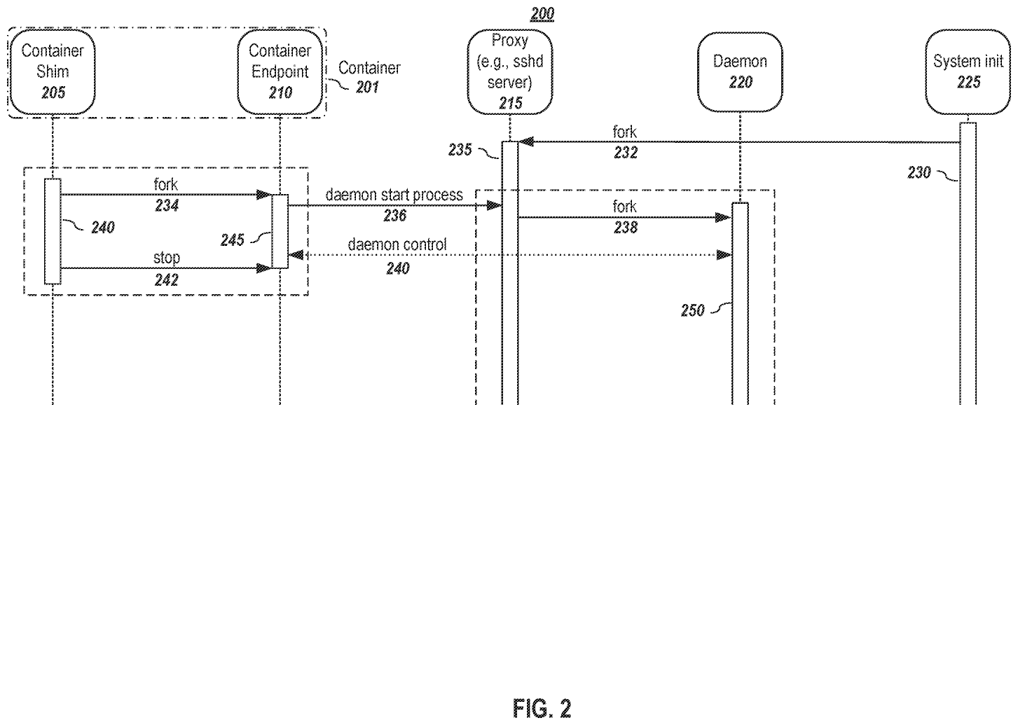

FIG. 2 graphically illustrates invoking a host process from a container process via a proxy process, according to embodiments of the present disclosure. Depicted in FIG. 2 is a container 201, which comprises a container shim 205 and a container endpoint 210. In the depicted illustration, the container shim process 240 spawns, via a fork call 234, a container endpoint process 245, and the container endpoint process initiates 236 a daemon process via a proxy process 215/235. Note that, in this depicted embodiment, the proxy process 235 was created by a system process (e.g., system init 225/230). The dashed boxes represent direct parent-child pairs of processes.

An example of a proxy process that may be used is a commonly available SSH server. Such a process is typically designed to constantly run on the compute host and allows a container process to open an SSH session to the compute host and create a background process (e.g., a daemon process 220/250). Another example implementation may be a process running as a systemd service on the compute host and listening on a Unix domain socket for custom RPC (Remote Procedure Call) calls from the container. If the systemd service does not need to restart by design, it can guarantee its descendant processes will not be terminated by the kernel prematurely.

Note that, in the depicted embodiment, the daemon process 250 and the container process 245 establish a communication channel 240 between them, if needed.

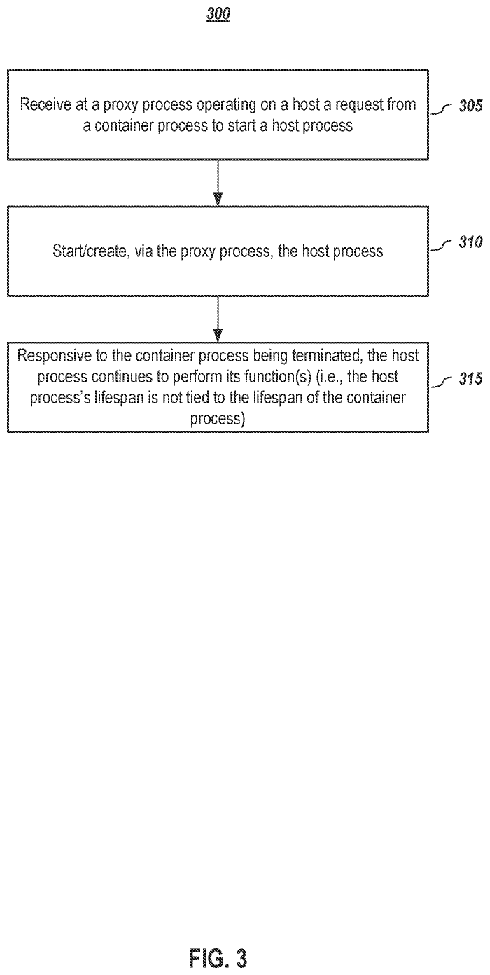

FIG. 3 depicts a methodology for invoking a host process from a container using a proxy process, according to embodiments of the present disclosure. In one or more embodiments, a proxy process operating on a host receives 305 a request from a container process to start a host process (e.g., daemon start process 236 in FIG. 2). The proxy process (e.g., sshd server 215 in FIG. 2) starts or creates (310) the host process. Note that by having the proxy process start the daemon process, the hierarchical process tree dependency of the daemon process is independent of the container process. Thus, responsive to the container process being terminated, the host process continues to perform its function(s) (i.e., the host process's lifespan is not tied to the lifespan of the container process).

### 2. Embodiments of Host Process Handling Following Termination (and Possible Restart) of the Container Process

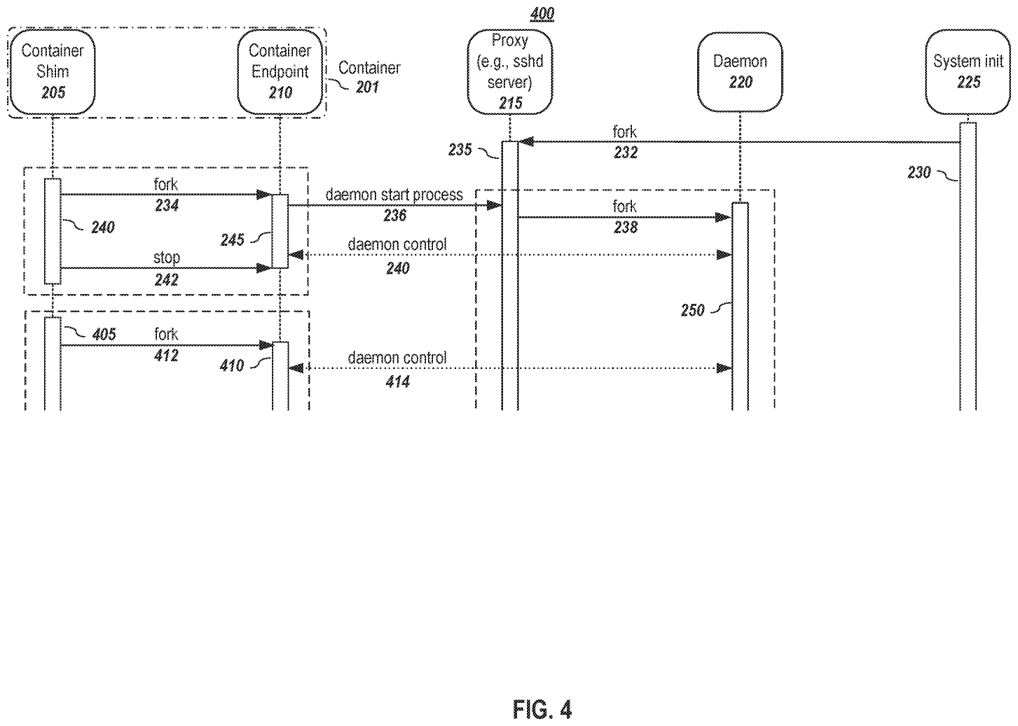

Turning now to FIG. 4, depicted is a scenario in which the originating container process 240/245 terminated but the daemon process remains alive. Note that, as illustrated in FIG. 4, the daemon process 250 continues to perform its function(s) even though the container process has terminated.

Next, consider a situation in which a new container instance is started or a container restarts. FIG. 4 also depicts the situation in which a daemon process survives and remains functional during restart of the container (i.e., the entrypoint and shim exit and start again). For example, container shim process 405, via fork 412, starts a container endpoint process 410. In one or more embodiments, the extant daemon process 250 and the container process 410 may establish a communication channel. The dashed boxes represent direct parent-child pairs of processes.

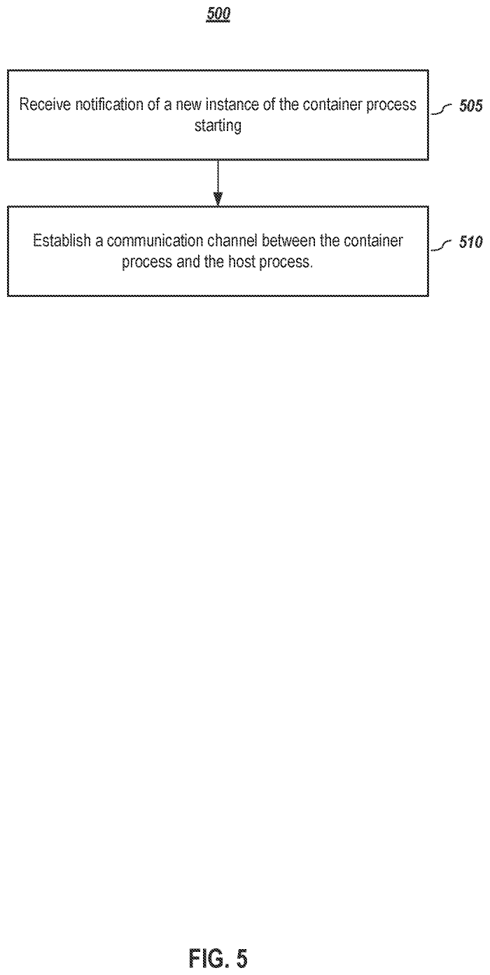

FIG. 5 depicts an example methodology for establishing connection between a new container instance and an existing host process, according to embodiments of the present disclosure. In one or more embodiments, the daemon process may receive notification that a new instance of the container process has been started (505) (or the container process has restarted). With the new instance started, the container process may be granted access to or may establish a communication channel with the pre-existing host process.

### 3. Embodiments of Host Process Handling Following Termination of the Proxy Process

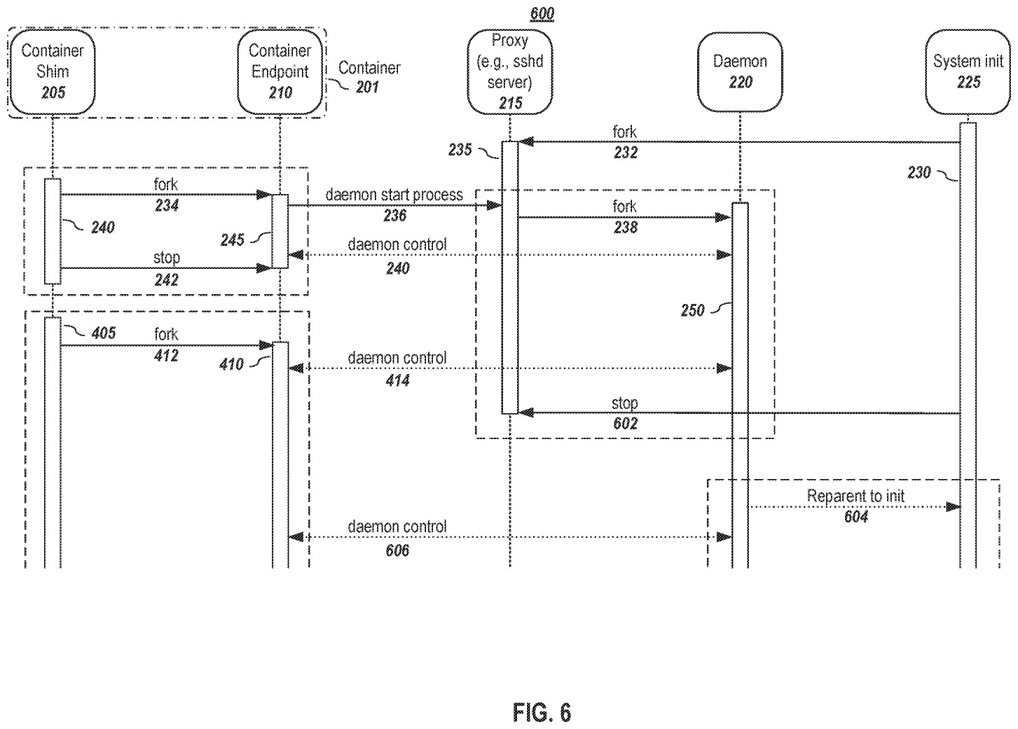

In one or more embodiments, if the proxy process terminates, the daemon process need not terminate. Consider, by way of illustration, FIG. 6. As shown in FIG. 6, the proxy process 235 has been terminated (602) by a stop command. In one or more embodiments, the daemon process 250 becomes an orphaned process, which may be reparented/adopted by a process higher on the process tree hierarchy. In this example, the daemon process may be automatically reparented/adopted (604) by the system init 225 process, which is the child reaper for the sshd server and is the longest living process available in the system. The dashed boxes represent direct parent-child pairs of processes.

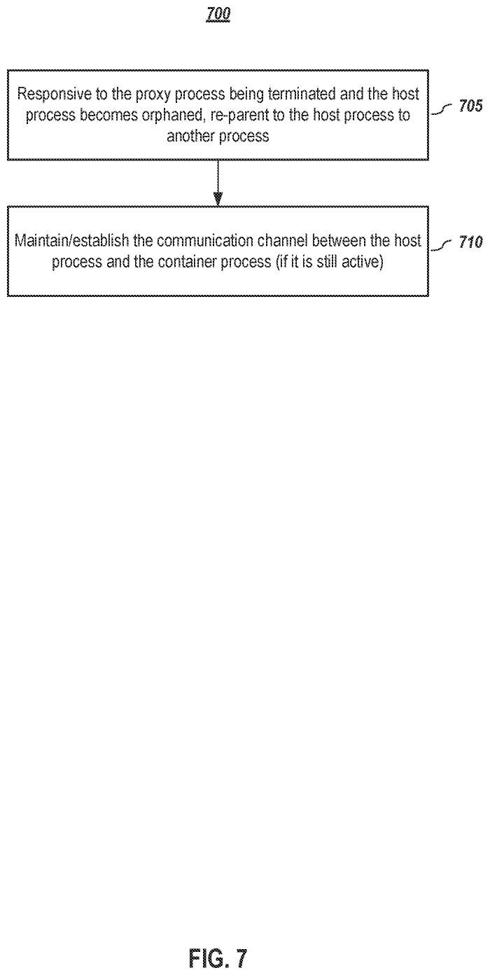

FIG. 7 depicts an example methodology for establishing connection between a new container instance and an existing host process, according to embodiments of the present disclosure. In one or more embodiments, responsive to the proxy process being terminated and the host process becomes orphaned, the host process is reparented (705) to a second process. Note that, in one or more embodiments, the communication channel with the container process may be maintained (or a new communication channel with the container process established) (710) in relation to the host process being adopted by the second process on the host. This daemon control channel 606 is illustrated in FIG. 6.

Note that if the container process is no longer active or if a communication channel to the container process is not required for the daemon process to perform it function, it need not maintain or establish such a connection.

### 4. Embodiments of Host Process Handling Following a New Instance of a Proxy Process

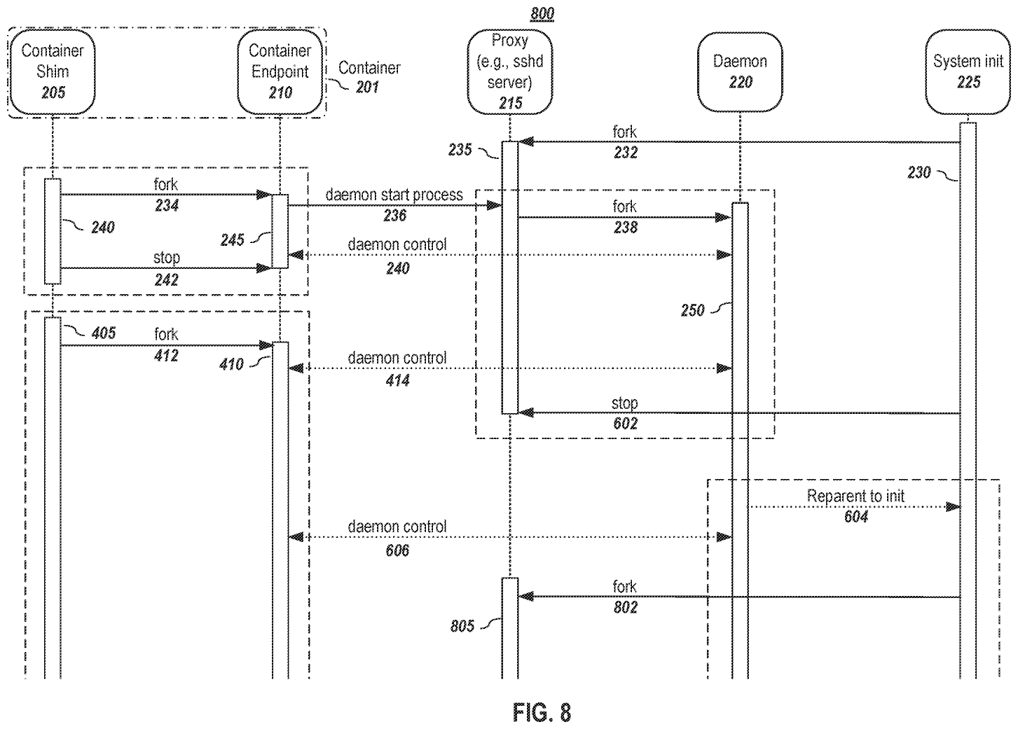

In one or more embodiments, if a new instance of the proxy process is started (or is restarted), the existing daemon process need not be reparented to it. Consider, by way of illustration, FIG. 8. As shown in FIG. 8, a new instance of the proxy process 805 was started (802) by the system init process 225/230. In this depicted embodiment, the daemon process 250 was not reparented to the new proxy process 805.

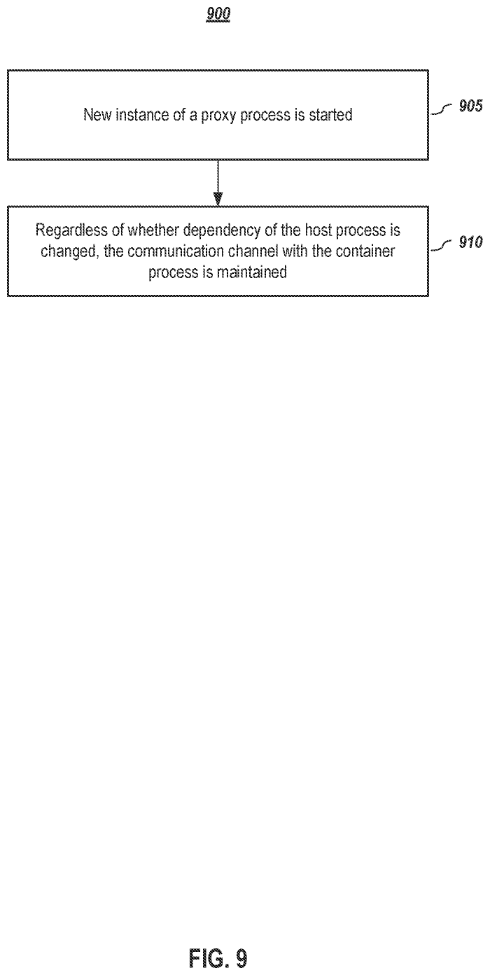

FIG. 9 depicts an example methodology for handling a new proxy process instance, according to embodiments of the present disclosure. In one or more embodiments, a new proxy process is started (905). However, regardless of whether the dependency of the daemon process is changed to the new proxy process or not, the communication channel with the container process is maintained during the dependency change, if one exists. Note that if the container process is no longer active or if a communication channel to the container process is not required for the daemon process to perform it function, it need not maintain or establish such a connection.

### C. Example Use Cases

An embodiment may be implemented with CSM (Container Storage Modules) for encryption, which is a Kubernetes CSI (Container Storage Interface) storage driver running as a containerized process. When Kubernetes requests a new volume, the driver, among other things, embeds a daemon process (e.g., a FUSE file system) that performs data encryption into the volume data path. Once the volume is initialized by the driver, it is attached to an application container which starts its data I/O. Availability of the encrypting process (i.e., the FUSE-based daemon process) is thus crucial for integrity of the data path, so it should remain running throughout the application lifetime. However, the driver may need to restart, for example to upgrade, so the FUSE process should be independent of the driver lifecycle. Thus, by implementing an embodiment of the present patent document that separates the life span of the FUSE process from the container, the driver may perform an upgrade/restart without impacting the FUSE process.

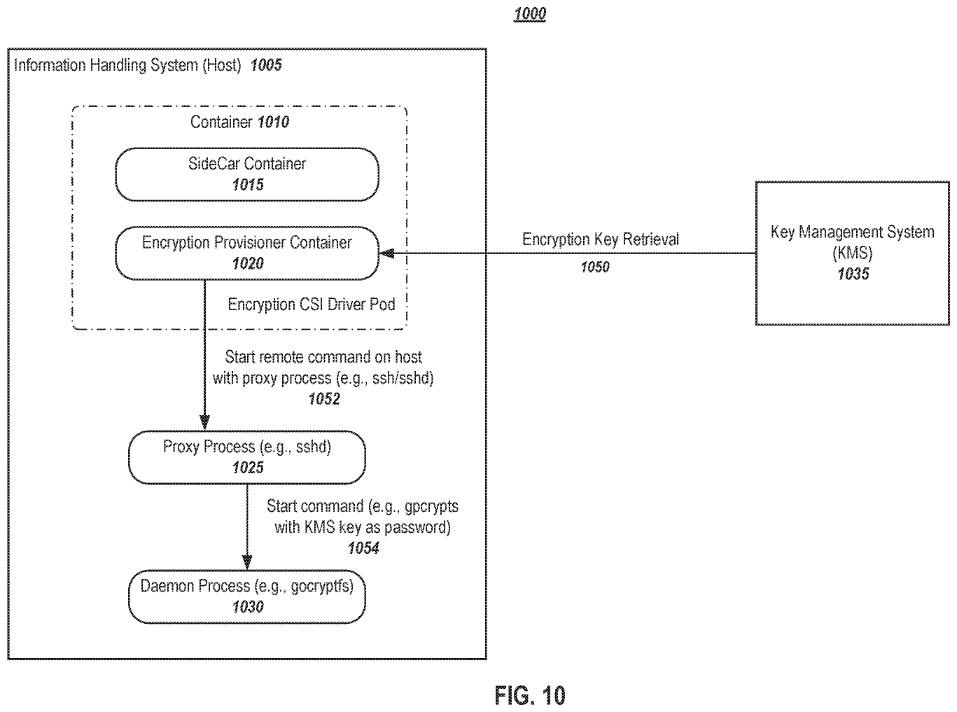

FIG. 10 depicts an example use case of an encryption driver, according to embodiments of the present disclosure. Depicted in FIG. 10 is an information handling system 1005 operating as a host. Within the host system, is a container 1010, which comprises a SideCar container 1015 and an encryption provisioner container 1020. Note that the encryption provisioner container 1020 interacts with a key management system (KMS) 1035 to obtain (1050) appropriate encryption keys.

In one or more embodiments, the encryption provisioner container 1020 may start (1052) a remote command on the host 1005 via proxy process (e.g., ssh/sshd). A proxy process (e.g., ssh/sshd) 1025 may then issue (1054) a start command (e.g., gocrypts with KMS key as password) to start a host daemon process (e.g., gocryptfs) 1030. Thus, by implementing an embodiment of the present patent document that separates the daemon process from the container, the daemon process may continue to function even if the container is terminated, restarts, etc.

### D. System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

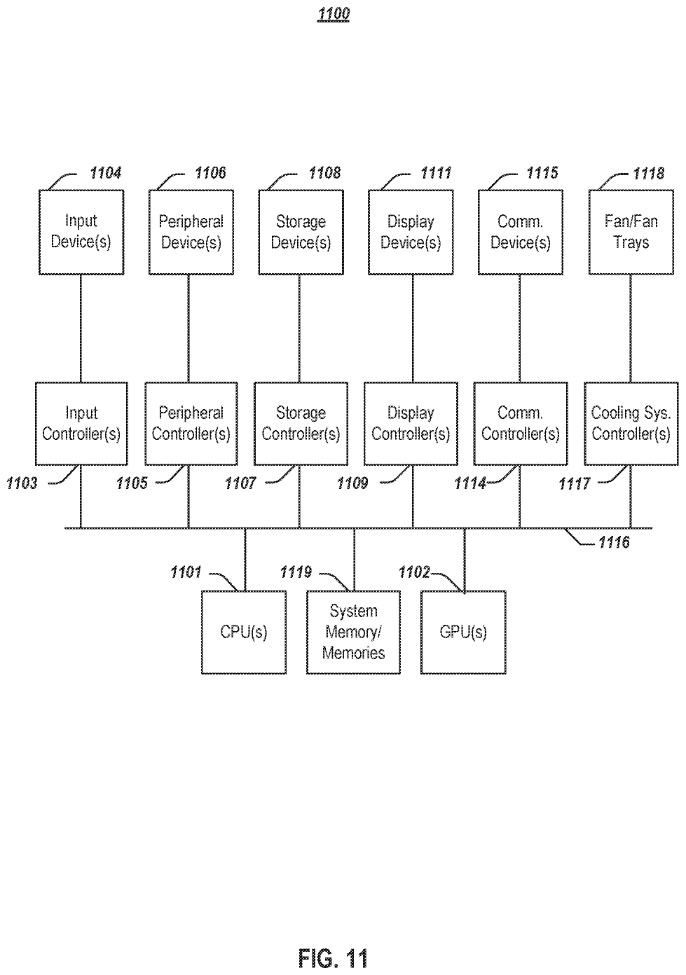

FIG. 11 depicts a simplified block diagram of an information handling system (or computing system), according to embodiments of the present disclosure. It will be understood that the functionalities shown for system 1100 may operate to support various embodiments of a computing system—although it shall be understood that a computing system may be differently configured and include different components, including having fewer or more components as depicted in FIG. 11.

As illustrated in FIG. 11, the computing system 1100 includes one or more CPUs 1101 that provides computing resources and controls the computer. CPU 1101 may be implemented with a microprocessor or the like and may also include one or more graphics processing units (GPU) 1102 and/or a floating-point coprocessor for mathematical computations. In one or more embodiments, one or more GPUs 1102 may be incorporated within the display controller 1109, such as part of a graphics card or cards. The system 1100 may also include a system memory 1119, which may comprise RAM, ROM, or both.

A number of controllers and peripheral devices may also be provided, as shown in FIG. 11. An input controller 1103 represents an interface to various input device(s) 1104, such as a keyboard, mouse, touchscreen, stylus, microphone, camera, trackpad, display, etc. The computing system 1100 may also include a storage controller 1107 for interfacing with one or more storage devices 1108 each of which includes a storage medium such as magnetic tape or disk, or an optical medium that might be used to record programs of instructions for operating systems, utilities, and applications, which may include embodiments of programs that implement various aspects of the present disclosure. Storage device(s) 1108 may also be used to store processed data or data to be processed in accordance with the disclosure. The system 1100 may also include a display controller 1109 for providing an interface to a display device 1111, which may be a cathode ray tube (CRT) display, a thin film transistor (TFT) display, organic light-emitting diode, electroluminescent panel, plasma panel, or any other type of display. The computing system 1100 may also include one or more peripheral controllers or interfaces 1105 for one or more peripherals 1106. Examples of peripherals may include one or more printers, scanners, input devices, output devices, sensors, and the like. A communications controller 1114 may interface with one or more communication devices 1115, which enables the system 1100 to connect to remote devices through any of a variety of networks including the Internet, a cloud resource (e.g., an Ethernet cloud, a Fibre Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1100 comprises one or more fans or fan trays 1118 and a cooling subsystem controller or controllers 1117 that monitors thermal temperature(s) of the system 1100 (or components thereof) and operates the fans/fan trays 1118 to help regulate the temperature.

In the illustrated system, all major system components may connect to a bus 1116, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

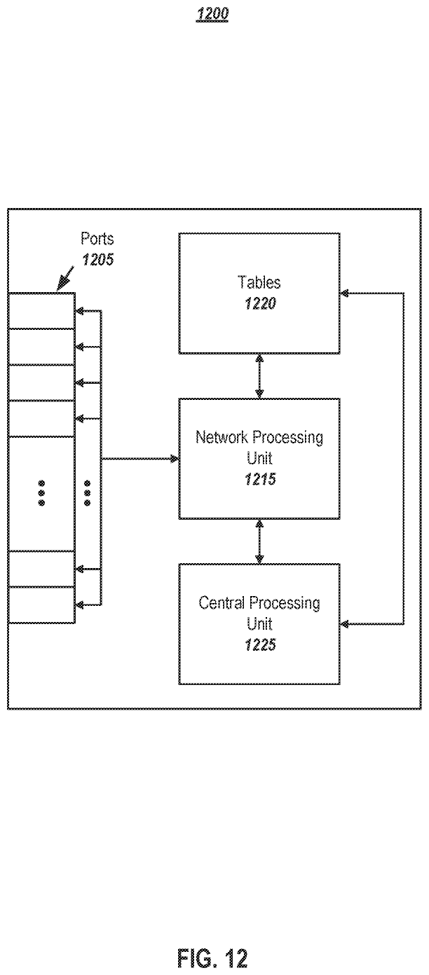

FIG. 12 depicts an alternative block diagram of an information handling system, according to embodiments of the present disclosure. It will be understood that the functionalities shown for system 1200 may operate to support various embodiments of the present disclosure—although it shall be understood that such system may be differently configured and include different components, additional components, or fewer components.

The information handling system 1200 may include a plurality of I/O ports 1205, a network processing unit (NPU) 1215, one or more tables 1220, and a CPU 1225. The system includes a power supply (not shown) and may also include other components, which are not shown for sake of simplicity.

In one or more embodiments, the I/O ports 1205 may be connected via one or more cables to one or more other network devices or clients. The network processing unit 1215 may use information included in the network data received at the node 1200, as well as information stored in the tables 1220, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method for invoking a daemon process from a container that is capable of outliving a lifespan of the container, the method comprising:
receiving, at a proxy process operating on a host, a request from a container process to start a daemon process on the host; and
starting, via the proxy process, the daemon process, wherein a lifespan of the daemon process is not affected by the lifespan of the container process.

2. The computer-implemented method of claim 1 wherein the step of starting, via the proxy process, the daemon process comprises:
starting the daemon process in which a hierarchical dependency of the daemon process is independent of the container process.

3. The computer-implemented method of claim 1 further comprising:
establishing a communication channel between the container process and the daemon process.

4. The computer-implemented method of claim 1 further comprising:
responsive to the proxy process terminating and responsive to the daemon process being dependent from the proxy process, causing the daemon process to be adopted by a second process on the host.

5. The computer-implemented method of claim 4 wherein the second process is a child reaper process that is capable of adopting the daemon process.

6. The computer-implemented method of claim 4 further comprising:
maintaining the communication channel or establishing a new communication channel with the container process in relation to the daemon process being adopted by the second process on the host.

7. The computer-implemented method of claim 4 further comprising:
responsive to creating of a second proxy process at the host, not changing dependency of the daemon process to the second proxy process.

8. The computer-implemented method of claim 1 further comprising:
responsive to a second container process starting after termination of the container process that requested the daemon process to be started, granting the second container process access to the daemon process.

9. An information handling system operating as a host comprising:
one or more processors;
a container operating on the information handling system, in which the container comprises a container process; and
a non-transitory computer-readable medium or media comprising one or more sets of instructions which, when executed by at least one of the one or more processors, causes steps to be performed comprising:
receiving, at a proxy process operating on the host, a request from the container process to start a daemon process on the host; and
starting, via the proxy process, the daemon process, wherein a lifespan of the daemon process is not affected by the lifespan of the container process.

10. The information handling system of claim 9 wherein the step of starting, via the proxy process, the daemon process comprises:
starting the daemon process in which a hierarchical dependency of the daemon process is independent of the container process.

11. The information handling system of claim 9 wherein the non-transitory computer-readable medium or media further comprises one or more sequences of instructions which, when executed by at least one of the one or more processors, causes steps to be performed comprising:
establishing a communication channel between the container process and the daemon process.

12. The information handling system of claim 9 wherein the non-transitory computer-readable medium or media further comprises one or more sequences of instructions which, when executed by at least one of the one or more processors, causes steps to be performed comprising:
responsive to the proxy process terminating and responsive to the daemon process being dependent from the proxy process, causing the daemon process to be adopted by a second process on the host.

13. The information handling system of claim 12 wherein the non-transitory computer-readable medium or media further comprises one or more sequences of instructions which, when executed by at least one of the one or more processors, causes steps to be performed comprising:
maintaining the communication channel or establishing a new communication channel with the container process in relation to the daemon process being adopted by the second process on the host.

14. The information handling system of claim 9 wherein the non-transitory computer-readable medium or media further comprises one or more sequences of instructions which, when executed by at least one of the one or more processors, causes steps to be performed comprising:
responsive to a second container process starting after termination of the container process that requested the daemon process to be started, establishing a communication channel between the second container process and the daemon process.

15. A computer-implemented method for invoking a host process from a container that is capable of outliving a lifespan of the container, the method comprising:
receiving, at a proxy process operating on a host, a request from a container process to start a host process on the host; and
starting, via the proxy process, the host process, in which a hierarchical dependency of the host process is independent of the container process.

16. The computer-implemented method of claim 15 further comprising:
establishing a communication channel between the container process and the host process.

17. The computer-implemented method of claim 15 further comprising:
responsive to the proxy process terminating and responsive to the host process being dependent from the proxy process, causing the host process to be adopted by a second process on the host.

18. The computer-implemented method of claim 17 further comprising:
maintaining the communication channel or establishing a new communication channel with the container process in relation to the host process being adopted by the second process.

19. The computer-implemented method of claim 17 further comprising:
responsive to creating of a second proxy process at the host, not changing dependency of the daemon process to the second proxy process.

20. The computer-implemented method of claim 15 further comprising:
responsive to a second container process starting after termination of the container process that requested the daemon process to be started, establishing a communication channel between the second container process and the daemon process.
